(19) United States
(12) Patent Application Publication
(10) Pub. No.: US 2004/0098493 A1
(43) Pub. Date: May 20, 2004

(54) Web page access

(76) Inventor: Owain Huw Rees, Cardiff (GB)

Correspondence Address: Darin J Gibby, Townsend & Townsend & Crew, 8th Floor, Two Embarcadero Center, San Francisco, CA, 94111-3834, US

(21) Appl. No.: 10/362,307

(22) PCT Filed: Aug. 24, 2001
(86) PCT No.: PCT/GB01/03809

(30) Foreign Application Priority Data
Aug. 25, 2000 (GB) 0021083.1

(51) Int. Cl. G06F 15/16

(52) U.S. Cl. 709/229; 709/227

(57) ABSTRACT

In a network accessed by a client access device (3) and an agent access device (8), there is disclosed a method and apparatus for the regulation by the agent of the degree of access available to the client (3) to Web pages at a Web host (9) in common communication the client (3) and agent (8) via the internet (6). The degree of access is determined after the client (3) has supplied identifying information to the agent (8), the agent being in control of the Web host (9) so as to variably determine what degree of access the identified client should have to Web pages provided by the Web host. Methods and apparatus are disclosed for the control of the Web host (9) by the agent (8) so as to regulate which Web pages the client views via the Web host (9), in what order they are viewed, and when. A method and apparatus for signalling to the agent, via the Web host (9), when a Web page is onloaded at the clients browser application (2) is disclosed, as is a method of disabling caching of data transmitted between the client (8) and the host (9).

### BACKGROUND OF THE INVENTION

1. Field of the Invention

The present invention relates to arrangements for controlling access by one person to a page of the World Wide Web provided by a second person.

2. Summary of the Prior Art

When someone attempts to access a Web site provided on an appropriate server, arrangements are already known in which there is some control over the access permitted. Although many Web-sites permit people accessing those sites to view any page of the site, it is also known to provide more limited access arrangements. For example, access to the Web-site or a part of it may be permitted only on input of a suitable password. In general, however, such known systems of access control have been limited. It is also known to permit access based on the source from which access is requested. The computer from which a person is seeking access has an appropriate unique identifier (such as its IP number) and access is permitted when that identifier corresponds to one for which the server has already been set to identify. In each case, the access control is determined by an input (password or computer identity) from the person seeking access. These systems do not permit a third party to control the access.

Once a person has accessed a Web-site, normal arrangements permit that person to access pages of the Web-site in a way determined by the person accessing the Web-site. There may be arrangements for permitting the order in which pages can be looked at, but the choice of when to change from one page to another is, in existing systems, either pre-programmed or under the control of the person accessing the Web-site. Thus, if a third party provides that Web-site, the third party cannot control, which Web page is being looked at, and thus what the person is seeing. This can be a problem in situations where the third party is in contact with the person accessing the Web-site via some other route, e.g. by telephone, and is discussing the Web-site with the person accessing it. The third party cannot be sure that the person accessing the Web-site is looking at the right pages. There are arrangements to permit a third party to track the activity of a person accessing a Web-site, i.e. to be told which part of the Web-site the person has accessed, after they have accessed it, these arrangements do not permit the third party of influence the person except passively.

This problem may be further compounded by the fact that Web pages take time to down-load from the Web-site to the computer of the person seeking access, and thus again the third party does not know whether the person accessing the Web-site can see relevant information on a particular Web page, or not.

It is known to provide Web-sites in which Web pages advance themselves to change the displayed content. There are three known ways of doing this. The first one is known as HTTP Meta-refresh but has the disadvantage that the time of successive page advancements is fixed. A similar disadvantage is obtained with the second method for advancing Web pages, known as JavaScript (ECMAscript). It is also known to use Applets, but the use of applets decrease the system security, and are therefore often disabled.

### SUMMARY OF THE INVENTION

The present invention seeks to develop arrangements for controlling access of a person to a Web-site, and in particular to permit a third party to control that access. The present invention has several aspects, concerned with different features of such control.

For the ease of subsequent description, a person connecting to a Web server to retrieve information for a Web-site will be referred to as a “client”. A person connecting to the Web server to control access of a client to the Web server will be referred to as a “agent”. In commercial situations, agents may be members of an “agent group”, being a group of agents from the same organisation or company. Furthermore, although references shall be made herein to “Web pages” accessible at a server, it is to be understood that this terminology is intended to include any form of information (such as multi-media information) accessible from a Web site and viewable on a browser. The term “Web page” is not intended to be limited to information embedded in a Web page.

The first aspect of the invention is concerned with permitting an agent to regulate, in real time or as nearly so as the Internet permits, the degree of access of a client to a Web-site or sites. At its most general, this aspect proposes that the agent is presented with information identifying the client and can vary the degree of access in a freely selectable way. At any time, the agent can vary the degree of access permitted. Thus, when the client seeks to access the Web-site they are required to communicate information by which they can be identified, and then the agent is presented with the identifying information to permit the agent to determine whether or not that client should access the Web-site, the agent determines the degree of access and is able at any time to vary that access.

The communication of information from the client may occur in one of two ways. It is possible for the client to input the information and for the information then to be transmitted to the agent. Alternatively, where the client and agent are in contact via some other route, for example by telephone, data may be presented to the client which is then communicated to the agent via that other route. The information is not a password, in the sense of a predetermined item which, if correctly input, determines the permitted degree of access. The information itself does not determine the degree of access but instead provides a way for the agent to identify the client i.e. to distinguish one client from another. The degree of access is determined by the agent and thus, unlike a password arrangement, the degree of access can vary with time as the agent chooses.

Since the aim of this aspect of the present invention is to permit the client to access an appropriate Web site, or selected pages thereof, there is not a direct link via the Internet between the client and agent, but instead both are in communication with a common server. That server may contain a database identifying clients, and be under the control of the agent. That server may also communicate with a secure data storage, and the server may then retrieve data from that storage only when the client's information matches that stored in the database, and the agent has authorised such access. Thus the client information stored is accessible by the agent and the agent controls the server to determine the degree of access. The agent may at any time vary the degree of access and the server can determine that the correct client is given that degree of access because of the identification of the client which is present on the server.

Thus, the database may be considered as storing a plurality of client sessions, and the agent is presented with a list of such sessions and can select and deselect any or all sessions, and can vary the degree of access for any or all sessions.

The database may comprise one or more memory locations for short-term data storage, such as a state register or the like, and/or one or more memory locations for long-term data storage (e.g. archiving).

The next aspect of the invention proposes that the agent is able to change the Web page which the client is accessing without requiring the client to trigger that intervention. It would be possible for the agent to change the Web page which the client is accessing by means of software downloaded on to the client's computer but this has security implications for the client, and is therefore undesirable. Instead, this aspect of the invention proposes that the client and agent each access a common server, and instructions from the agent to that server then control which Web pages the client sees. This obviates the need for the client computer to employ specialist software other than that employed in standard HTML compliant browsers, since it is the common server that is controlled by the agent and not the client computer.

Normal Web browsers only permit requests to be transmitted from the client's computer to a server to which that computer is connected, and therefore it is not normally possible for the agent directly to control what is requested by the client. However, in this aspect, the client controls the content of the Web page which is sent to the client in response to a request from the client, thereby permitting the agent to control the Web page seen by the client without the agent controlling the client's computer. Requests are repeatedly and regularly transmitted from the client's computer to the server, and the agent controls how the server responds to such requests. The request may simply cause the current information to be resent, but this can cause a flickering of the client's screen.

Therefore, it is preferable that Web pages are provided to the client which contain at least two frames, one of which contains the information that the client is to see and the other (which is not normally visible or is of insignificant size e.g. less than ten pixels in extent along its minimum dimension, such as its height, or width) is a refresh instruction. After a suitable delay, e.g. Is, that refresh instruction is transmitted back to the server as a request to re-transmit the corresponding pair of frames. When the agent does not want to change the Web page seen by the client, only one of the pair of frames (the one containing the refresh instruction) is transmitted to the client in response to the request from the client so the information which the client sees does not change. However, since that refresh instruction is a request to retrieve data from a particular site, if the agent changes the site corresponding to that refresh instruction, the client will be presented with a different Web page at the next refresh operation. The refresh instruction will then cycle, refreshing only the frame with the refresh instruction until the agent again changes the data to which the refresh operation is directed. Thus, the client is repeatedly sending requests to the server, but only the frame containing the refresh instruction (which is not visible or is insignificant) is updated, eliminating screen flicker, unless the agents decides to change what the client sees.

This aspect of the present invention is not limited to the transmission of two frames, and additional frames may be transmitted in each step of the refresh cycle to permit the agent to have further control operations or to provide additional information to the client.

It should be noted that, in practice, where the agent changes the data to which the refresh instruction is directed, thereby changing the content of the frame to be seen by the client, the refresh instruction may also changed, so that the whole page is re-loaded into the client's computer, rather than having the same refresh frame.

As has previously been mentioned, it is desirable that the agent knows that the client is viewing a particular Web page. Since downloading of the Web page to the client's computer takes time, and that time is dependant on factors out of control of both the client and agent, it is already known for a server to record in a text log file information about access to it, including the fact that the page has successfully been downloaded. In another aspect of the invention, it is proposed that that information is passed to the agent in real time, so that the agent knows when the page has been downloaded, and so knows that the client can view the information on that page.

It is possible for the server to signal to the agent when it has completed its transmission to the client. However, use of the Internet means that there may be proxy servers between the client and the server controlled by the agent. Normally, such proxy servers can be ignored when considering Internet transmissions, but they introduce delays in transmission of data from the server controlled by the agent to the client. Thus, if an agent relied on signals from the server indicating that the server had completed its transmission, that would not necessarily correspond to the information having been loaded onto the client's computer.

It is already known that when a Web page is downloaded from a server to a client, the client's computer generates a signal when the page has been downloaded. This is known as an “onload” event, and usually results in a signal within the client's computer such as a “done” signal visible to the client. However, it is now proposed that the Web browser at the client's computer signals the onload event to the agent indicating the occurrence of the onload event. More generally, it is proposed that any signal which is generated by the client's computer in response to the successful downloading and display, at the client's computer, of information from a Web site may be used to indicate an onload event. The signal may be sent directly to the agent or to the server, and the server interprets that event, and generates a signal to the agent. Thus, the agent knows when the download of a Web page is complete. As has previously been mentioned, normal Web browsers only permit requests to be sent from client's computer to the server, but the use of multiple frames as previously described means that information in the form of a request can be transmitted to the server which information represents the occurrence of an onload event indicating that the download of the Web page has been completed, but which information is in the form of a request to the server. In this aspect, the request merely affects a frame which is not visible or is insignificant to the client, but the server may signal to the agent using that request as a trigger.

The World Wide Web uses a system of storing Web pages to reduce the overall Web bandwith on the Internet. This arrangement is usually referred to as caching. However, Web pages that change their content regularly can be disadvantageously affected by this. Although there is a known method of disabling caching, this does not always work because some arrangements ignore the header parameters which disable page caching.

Another aspect of the present invention is concerned with providing an alternative way of disabling caching, and proposes that each request is uniquely different, such as by incorporating data representing the time (a time stamp) or a randomly generated number.

### BRIEF DESCRIPTION OF THE DRAWINGS

An embodiment of the present invention will now be described in detail, by way of example, with reference to the accompanying drawings, in which:

FIG. 1 is a schematic block diagram of a network in which the present invention may be embodied;

FIG. 2(a) illustrates and arrangement in which an agent is connected by the Internet to a single client;

FIG. 2(b) shows and arrangement in which an agent is connected via the Internet to multiple clients;

FIG. 3 is a flow chart showing the operations required in an embodiment of the invention which a client logs on to a server controlled by an agent;

FIG. 4 is a flow chart showing the operations carried out when an agent logs on to a server to which the client will access;

FIG. 5 is a flow chart showing the operations carried out in an embodiment of the invention to enable an agent to authorise a client to access appropriate information;

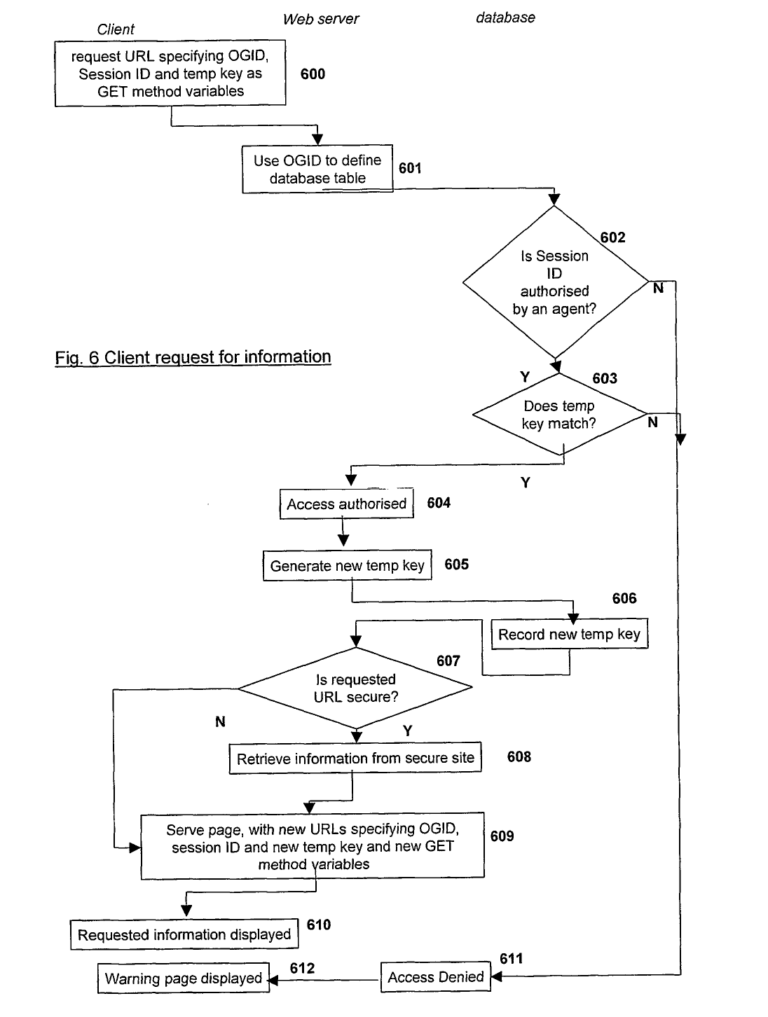

FIG. 6 is a flow chart showing the operations carried out when a client requests information;

FIG. 7 is a flow chart showing how the agent may send information to client, and FIG. 8 shows how the information in FIG. 7 is then delivered to the client; and

FIG. 9 is an example of a session table used in the embodiment of the present invention.

### DETAILED DESCRIPTION

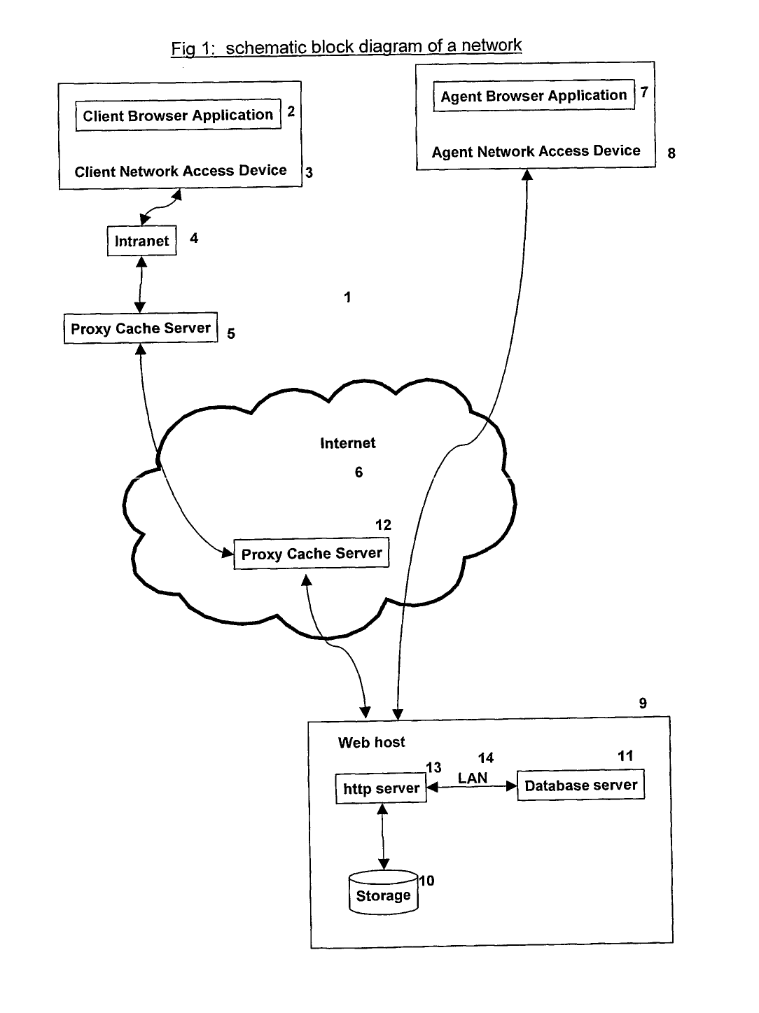

FIG. 1 illustrates an architecture-level block diagram of a network as an example of the network in use for this invention. The network 1 includes one or more client network access devices 3. Each client network access device can comprise a microcomputer including a central processing unit, memory and a network adaptor for communication, all linked by a bus. Each client network access device 3 is contains a client browser application 2 that provides a user interface allowing data to be viewed, and any necessary instructions to be transmitted. This client network access device typically includes a screen, and may also include a keyboard and screen cursor manipulator such as a mouse, a remote control or voice recognition. The client network access device is linked to the network to which the Web host 9 is also connected. This network would typically be, as illustrated in FIG. 1, the Internet 6, a large number of independent nodes and routers that enable the transfer of TCP/IP formatted data packets to and from a large number of remote sites. The connection may be indirect as shown in FIG. 1. The client network access device 3 can be linked to an intranet 4, and the connection from the intranet 4 to the Internet 6 may be through a proxy cache server 5. Within the route taken by the data from the web host 9 over the internet, there may be additional proxy cache servers 12 operated by Internet Service Providers for the purpose of reducing traffic data volumes or otherwise.

For this invention, the controlling Web host 9, contains three core elements. These are an Hypertext transfer protocol (HTTP) server 13, comprising software for responding to requests for data and returning any legitimately requested material to the client or agent network access devices, for example the Apache Web server software. There is also a database server 11, for storing both short and long term data about accounts and account activity, containing software such as the RDBMS package MySQL. Thirdly, the web host contains storage 10 for contents for the Web-site. These elements of the web host may be running on one or more computers, each also containing a CPU, memory and network adaptor linked to a common bus. Where more than one computer is used, these may be connected either via the Internet, or preferably via a local area network (LAN) 14.

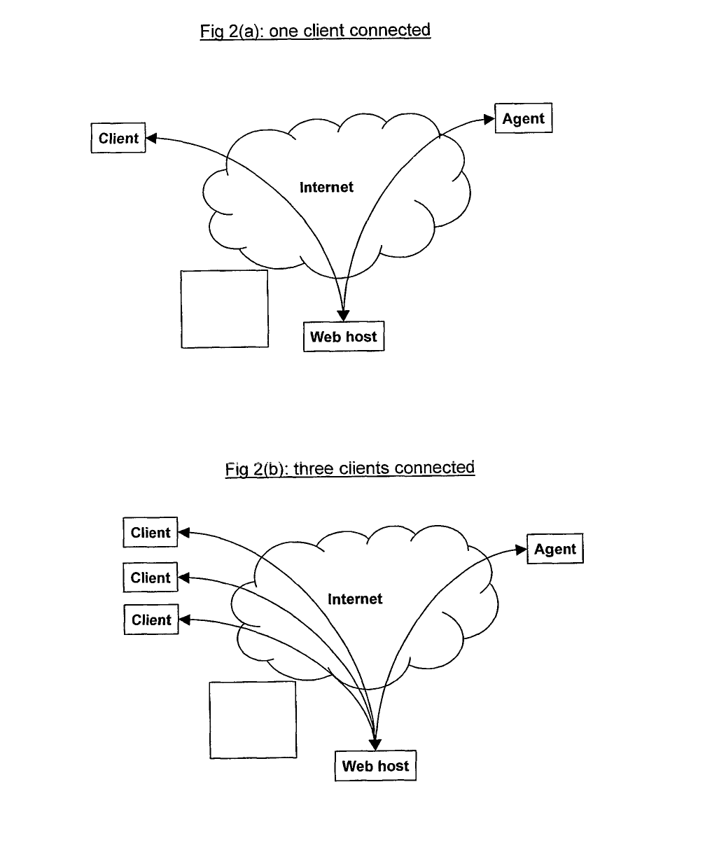

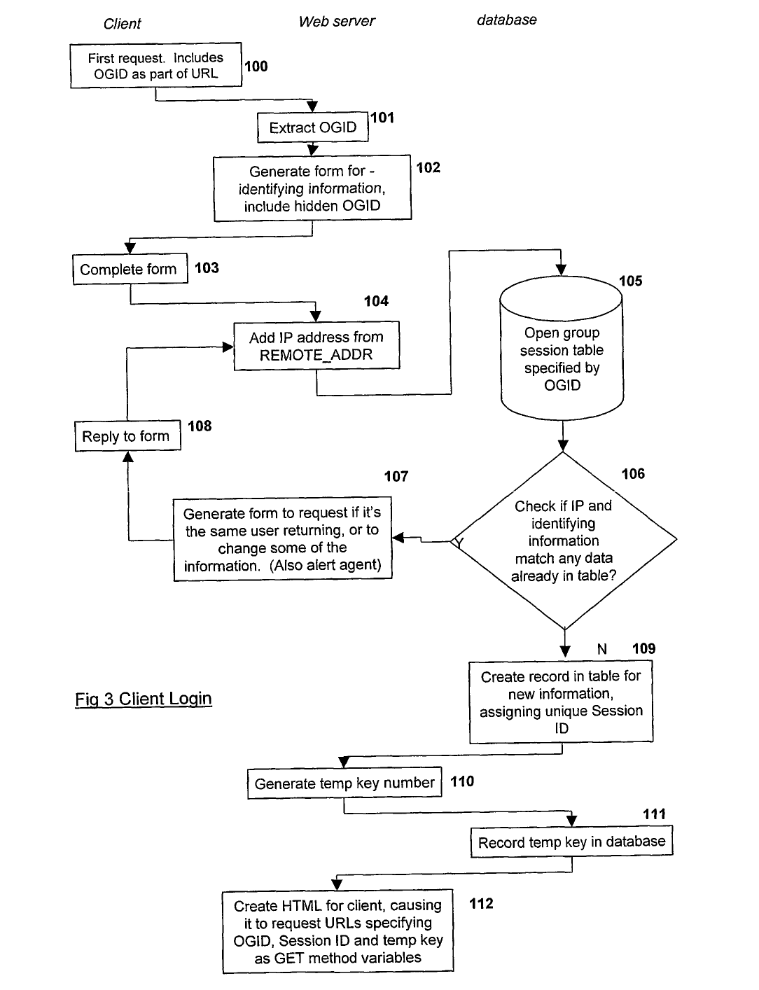

An unlimited number of clients may be connected, via the Internet 6. For this invention, these would be grouped into sessions, in which one client would play the role of agent. Sessions with 1 agent and 1 client, or 1 agent and 3 clients, are shown if FIG. 2(a) and FIG. 2(b) respectively.

A TCP/IP connection is established between the client browser application 2 and the Web host 9. Establishment of a TCP/IP connection entails the prior configuration of various IP addresses, usually represented in a dotted decimal notation or dotted hexadecimal notation in each of the computers, routers, management stations and workstations currently resident on the network. Certain IP network numbers are reserved for use by particular aspect of TCP/IP communication. The address is provided as a header to a data packet sent between a sender and a recipient. Router functions within the network strip the header and delivered associated data within the packet (e.g., instructions and information) to the designated addressee/recipient. The recipient provides a TCP header for additional reliability. TCP headers, in combination with application layer data are usually termed a segment. The segment can include a variety of data that are returned to the sender to ensure that the original IP message was properly received.

Consider now the case where an agent is to control which clients may access which pages of the Web-site. In this embodiment, it is assumed that the agent has some form of communication with the client, such as by being in contact with them by telephone, as it should be noted that the present invention is not limited to the case where the agent has such contact with the client.

There are several operations that must occur before the agent can control the Web pages that the client sees. The first stage is that the client must go through an appropriate log-in operation to ensure that appropriate Web pages are displayed only to identified clients. Similarly, the agent must carry out a log-in operation to permit the agent to have the right to control what the client sees. Next, an agent which has validly logged-in must then authorise a validly logged-in client to access the information, and the client's browser application must then make the appropriate request. The agent may control the Web pages that the client sees (agent push) and that pushed information must be delivered to the client with the agent being able to determine when the client has received the appropriate information. Each of these stages will now be described in more detail.

Each agent or agent group is allocated a unique identifying number (OGID).

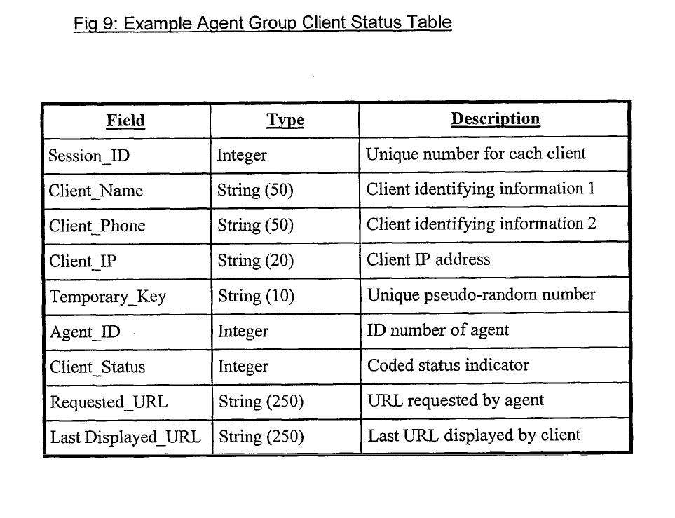

A database is created that contains details of all agents and agent groups. In particular, it contains session tables for monitoring when clients are in, or attempting to enter, a communications session with an agent. Each of these session tables will have name that is made unique through the addition of the OGID. For example, cstb_{—}123456 may be the session table for the agent group with OGID 123456. An example of such a table is given in FIG. 9. As is seen, there are fields to contain the client session ID number, the identifying personal information of the client the IP address sent by the client network access device as part of the TCP/IP packet header, the status of the client (ie if they have been selected by an agent) and an agent ID number if they have been selected. Other information may also be stored in this table.

The client commands the client network access device to request access to a particular Internet Web-site address (client log-in) by issuing a Hypertext Transfer Protocol (HTTP) request through the client browser application. The request is provided in a format recognizable as an Internet Web-site address, for example. “http://www.claripoint.com”. This type of address is referred to as a Uniform Resource Locator (URL).

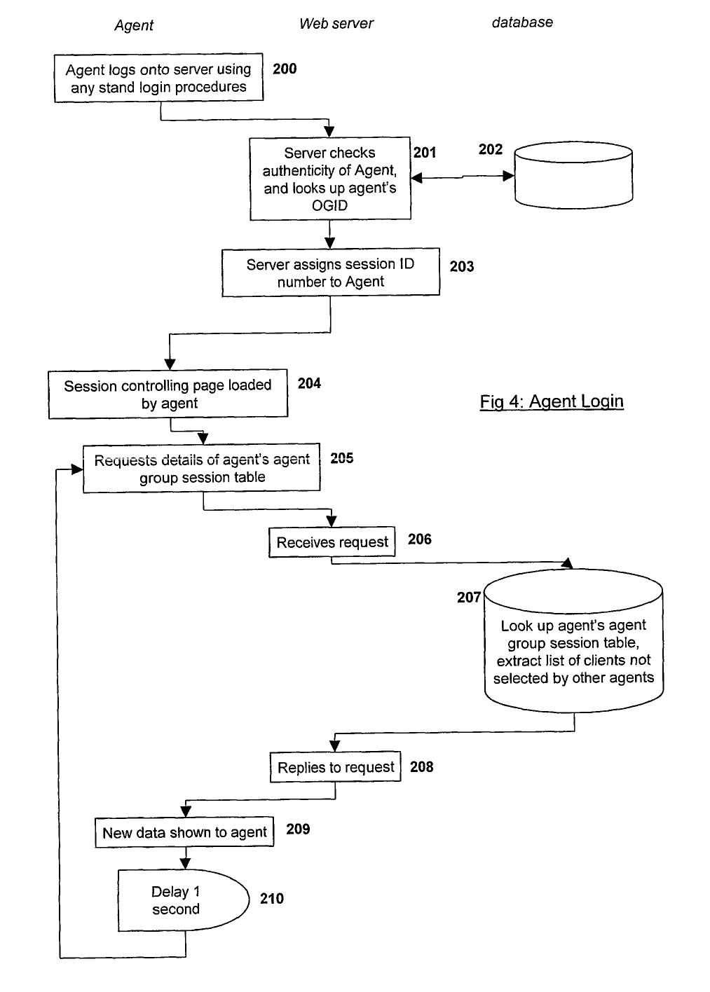

In this example, the client would add OGID to the Internet Web-site address. This is illustrated at step 100 in FIG. 3. For example, http://www.claripoint.com/123456. This OGID number identifies the group to which the client's agent belongs, and hence means that the agent can be notified of the presence of the client visiting the Website. To make it easier for the client, the complete URL including the OGID can be hidden as a hyperlink from the agent's own Web-site, or a more memorable name can be used instead of the OGID and aliasing or other known means used on the http server to redirect the URL with the name to the URL with the OGID. The http server first separates the OGID from the URL (step 101 in FIG. 3), and responds to the requested URL by displaying a display presentation, such as a form, to the client in which the client may enter some personnel identifying information, for example name and telephone number (step 102 in FIG. 3). Alternatively, the page returned may have other unique information generated by the server, such as a simple number, word or picture that may be simply described to the agent by the client and hence allow the agent to identify the computer connection that the client is making. In both these cases, the http server embeds a hidden field (within a standard. HTML form using the <input type=“hidden”> notion) containing the OGID of the agent group, or otherwise adds the OGID to the reply so that the next client request also contains the OGID.

The second request from the client to the http server will then contain the OGID, as well as the information from which the agent can uniquely identify the client. This could for example be the client's name and telephone number.

When the client completes the form (Step 103) the http server adds an IP address (step 104) and the http server communicates with the database server to establish a new session for the client, and record its details within the session table for the agent's agent group (step 105). First, a check is made for any pre-existing data in the table that matches the personal customer information and the IP address from the TCP/IP data packets from the client network access device. (http servers typically make this address available as the environment variable REMOTE_ADDR). If the personal details match, but the IP address is different, this could simply be a co-incidence (for example if the agent has only requested a first name, and two clients with the same first name have logged on). Equally if the IP numbers are also identical a proxy server acting as a firewall could have caused this. However, a matching set of data could also indicate an attempt is being made by a third party to masquerade as the client. In this case, seeing only identical personal information, the agent would be unable to select the correct client. With this uncertainty, the http server will deliver a new form to the client network access device asking that a change is made to the data, for example to add an extra number to the client name (step 107). When re-submitted (step 108), this should provide a unique data set but if not, steps 107 and 108 may be repeated until a unique identification is possible. When a unique set of personal identifying information has been thus obtained, it is written to the agent group session table (step 109). The database server is responsible for generating a unique client session ID number that is added to this record in the database as the record is created.

Before responding to the client, the server creates a temporary key (step 110), which is a unique pseudo-random number. This key is recorded in the database (step 111).

The http server generates the response to the client network access device. All URLs contained within the response HTML page, whether static links or included in JavaScript or meta tags, will have the OGID, client session ID number and additionally a time stamp appending to the URL in the standard GT format of attaching variables to URLs, for example, http://www.asite.com/page.htm?variable1=value1&variable2=value2.

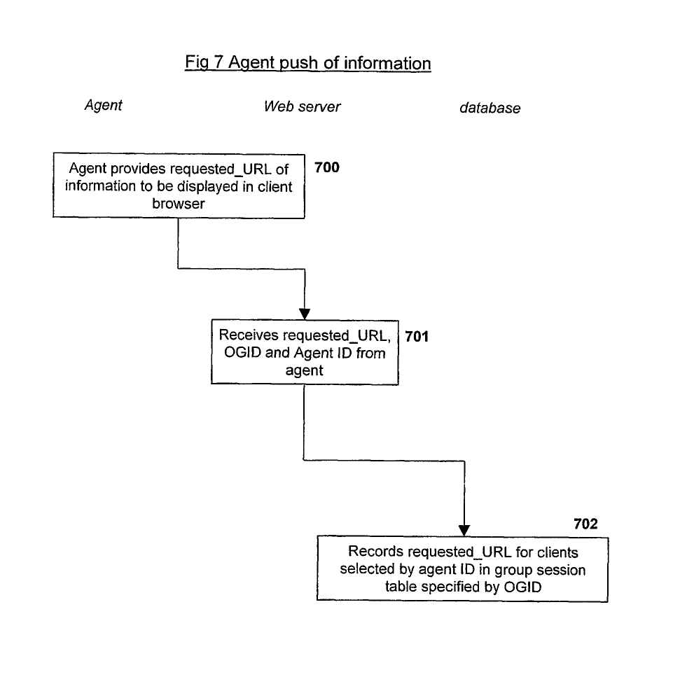

This will be repeated to ensure that every request made by the client identifies that client with the OGID, client session ID number and last temporary key issued (step 600 in FIG. 6) such that the client status and validity of the request can be checked against the database. This process is illustrated further in FIG. 6 and described below.

The http server is able to use the OGID to select the appropriate table within the database (step 601). The database will first check that the client, as identified by the session ID, remains authorised by the agent to view the material specified by the URL address (step 602). As a security check, the database will then check that the temporary key supplied by the client matches that previously issued to the client (step 603). If the client request passes both steps 602 and 603, the http server is told to authorise access (step 604), otherwise access is denied (step 611) and an appropriate warning page is returned to the client (step 612). If access has been authorised, a new temporary key is generated (step 605) and recorded in the database (step 606). Information to be displayed would normally be held on a secure http server, requiring user identification and password to access the said information. However, this procedure may also be used to authenticate a request for non-secure information. The http server can be told of which of these modes to operate by a field set by the agent within the database (step 607). If the information to be displayed is held within a secure space within the storage, the http server may retrieve this information itself, using its own name and password, on behalf of the client (step 608). The http server may then create the page containing the requested information, and again append the OGID, client session ID and the new temporary key to any URLs included (step 609).

If it is known that the client browser application is programmed to accept cookies, then these may be used to provide the numbers required for client authentication, instead of the GET method.

To logout the client can be provided with a hyperlink that causes the http server to request that the database server removes the client's details from the relevant agent group client session table. Alternatively, a regular routine on the database server will detect and delete clients who have not accessed the server within a fixed time period.

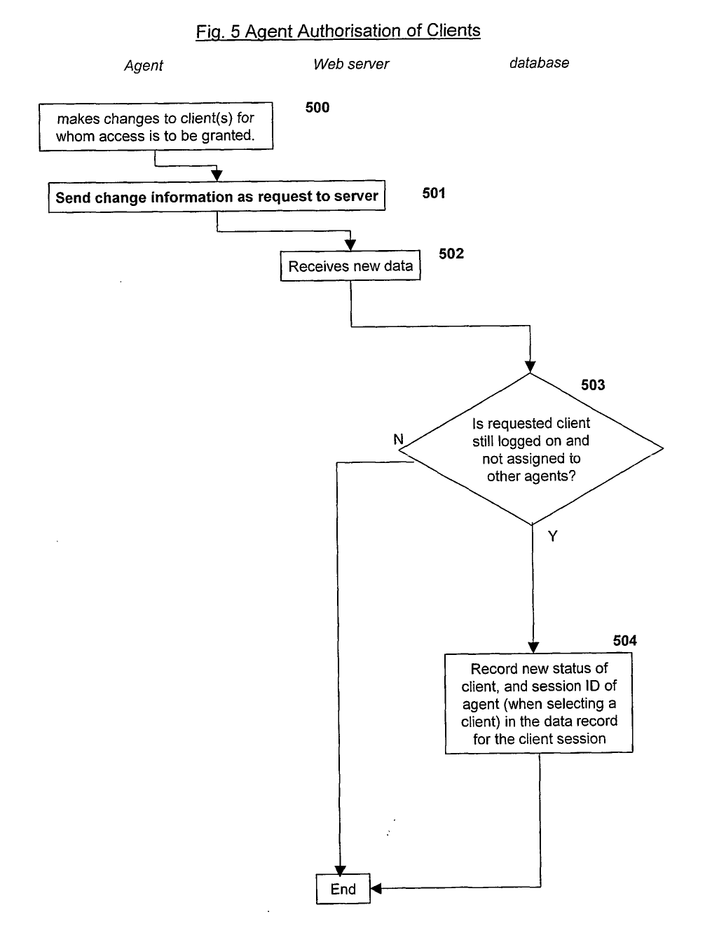

For the above to function, the agent must also be logged into the same Web host. This is illustrated in FIG. 4. The agent may have their access controlled by a standard and well-known means of username and password control or otherwise. Having entered his username and password into a log-in page on the Web-site (step 200 in FIG. 4), these values are tested (step 201) against those stored in the database (step 202). If authorised, the agent is assigned a temporary session ID key that is checked on each request that they make to the server (step 203).

Key data from the agent's agent group session table is extracted and displayed to the agent within the browser application of their client network access device (step 204). As the information will change when new clients login and logout, it is important that this information is refreshed regularly. In this embodiment this is achieved by a Java applet running in the Web browser of the agent, although simple HTML pages using META-REFRESH to refresh themselves or other means could be used.

The agent's Java applet directly requests the information from the http server using the standard HTTP protocol (steps 205 to 207). The information that is returned (steps 208 and 209) includes the identifying information entered by the client for each of the clients that are logged into the http server for the agents agent group, except those who are currently selected by other agents within the agent group.

Further security checks are performed by the Java applet on the agent's client network access device communicating with an ‘alive’ signal every second to the http server. Again, a sequence of unique temporary keys, cookies or other means may be used to authenticate the requests from the agent and to ensure that session security is not compromised by duplicated requests from a third party. A separate process is run on the http server to ensure that all agents remain connected. If contact with an agent is lost, caused for example by him logging off or his connection to the Internet failing, then the http server will detect this, and send an instruction to the database server to de-select all of the clients whom the agent had selected within that agents agent group client session table. Thus, in FIG. 4, steps 205 to 209 are repeated with a short, say 1 second, delay 210.

The agent is able to select which client(s) he wishes to authorise from the interface of the Java applet (step 500). After the agent has made this selection, the applet sends the request to the http server (step 501). This request is sent as a POST request, containing an instruction to the server as to the change or action required, the details to identify the appropriate clients, and the necessary information to identify and authorise the agent.

As the status of the client could have changed even in the very short time since the agent was last presented with the status information, the http server first retrieves new information from the agent group client session table to check that the client is still logged on, and that the client has not been selected by another agent in the group (step 503). Provided these are both true, the http server will send a request to the database server to update the agent group session table with the information that the chosen client is now selected, and the agent ID of the agent who has made the selection (step 504).

Having described how the client and agent both log on, how the agent may select a client, and how the client's browser application requests can be checked for authorisation by the agent, the method by which the agent can specify the information to be displayed in the client's browser application will now be described.

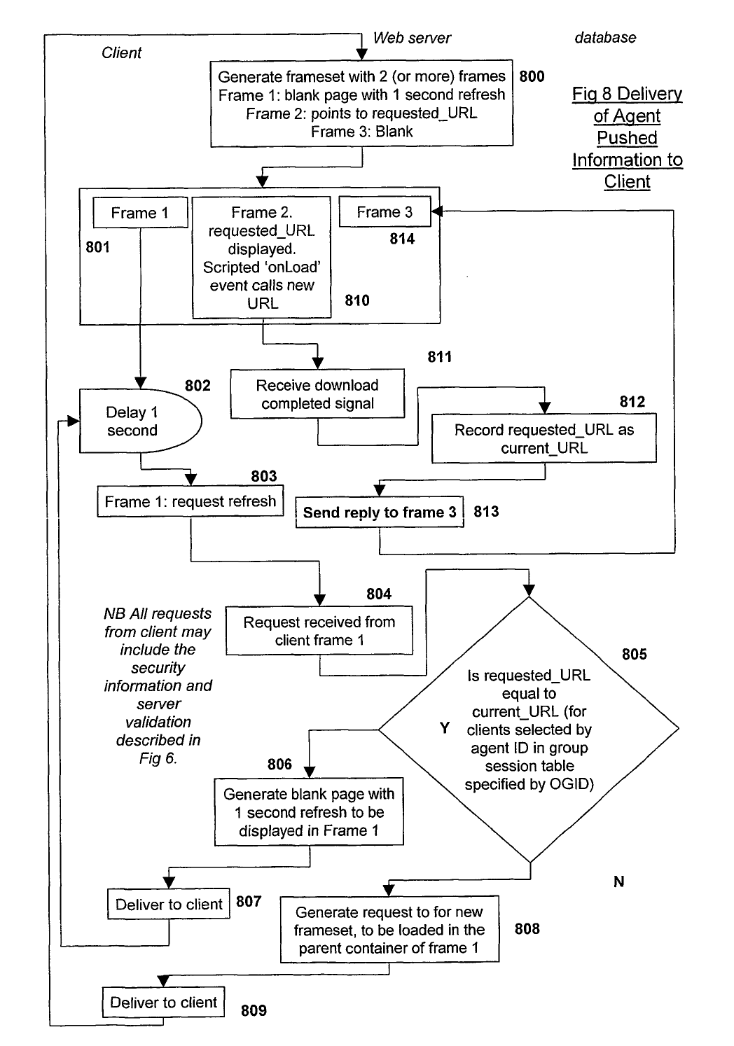

First, the agent must specify the material that he wishes his selected client(s) to see, a process illustrated in FIG. 7. He specifies this as a URL (step 700), being the correct form to address information for retrieval over the Internet by a client browser application.

Having made his selection, which may be by means of an activeX control or Java applet or otherwise to provide him with an easy interface, this URL is passed from the agent's browser application to the web host (step 701). This is again in the form of GET/POST request containing the instruction, the URL and the necessary information to identify and authenticate the agent.

The http server instructs the agent group client session database to record the new requested URL in each of the rows of data representing the clients currently selected by that agent. The database will contain for each client both the URL requested to be displayed, and the last URL displayed by the client (FIG. 9).

The ‘push’ of information to the client is created by a regular request for information by the client, a process illustrated in FIG. 8.

The http server generates and delivers a page containing 2 or more frames to the client network access device (step 800). The first of these frames is made almost invisible but limiting its height to just one pixel high, and removing all borders and scroll bars.

The URL for the contents of the first frame (step 801) is a page generated by the http server. It is a very simple page, normally containing all of the elements described above for the authentication of the client requests as well as a <meta http-equiv=“refresh” content=“1”>. This causes this scarcely visible page to request a new copy of itself every second (steps 803-804). Because each request has a new temporary key, the full URL is different for each and every request, even from the same client. (This further ensures that proxy cache servers reliably pass the request to the web host, as it has been found that some of the available proxy cache servers do not correctly implement the no-cache pragma.)

One receiving the request, the http server will establish if the agent requires new material to be shown to the client. It does this by comparing the contents of the fields for the requested URL and the last displayed URL in the database (step 805). If these fields are the same, the server simply issues a new simple page with a new temporary key and another 1 second refresh (steps 806-807). Until the agent changes the field for the requested URL as described above (step 702), steps 802807 repeat.

However, if the material to be shown by the agent to client has changed, when detected in step 805 the http server will instead create (step 808) and deliver (step 809) a page to frame 1 containing an instruction (in JavaScript or another language understood by the client browser application), requesting that the full frameset be reloaded (step 800).

The second frame that is generated within the full frameset is the frame in which the requested material is displayed. This is accompanied by a short JavaScript that is triggered by the client's browser application ‘onLoad’ event when the information is fully displayed (step 810). This may request a new URL from the http server, and the receipt of the URL request (step 811) signals that the information has been fully downloaded. This provides a more reliable feedback mechanism than relying on the server log to establish when the material has been delivered, as again the presence of proxy servers between the web host and the client can mean that the information has left the web host well before it arrives at the client.

The http server requests the database to update the latest URL displayed by the client (step 812). Finally, as the http server must respond to the request sent by the client browser application, even though in this instance no request is desired, the response is a blank page shown in another almost invisible frame (steps 813/814).

Having allowed the agent to specify the information to be displayed to the client, this embodiment also allows the agent to receive feedback of when that information is displayed to the client. This happens in the following manner. It has already been described how by comparing the requested URL field and the last displayed URL field, it is possible to identify if the information is downloaded, as is done in step 805. It has further been described how the agent regularly requests information from the same agent group client session table in the database (steps 205-210). The status of whether or not the client has successfully completed the download of the last requested information can be added to the information collected by the agent in this sequence, and appropriately displayed to the agent.

1. A method of regulation by one or more agents of the degree of access to one or more World-Wide-Web sites available to one or more clients of said one or more World-Wide-Web sites, the method including the steps of: placing at least one of the one or more clients and one of the one or more agents in communication with a common Web host; requesting of the one or more clients information identifying each of the one or more clients for communication to the one agent; communicating said client identifying information to the one agent, whereby the one agent controls said common Web host to regulate the degree of access available to the identified one or more clients thereat.

2. A method of regulation according to claim 1, wherein said information identifying the one or more clients is requested via said Web host, is subsequently returned to said Web host, and is then communicated to the one agent from said Web host.

3. A method of regulation according to claim 1 or claim 2, wherein the one agent controls said common Web host so as to variably regulate said degree of access.

4. A method of regulation according to any preceding claim, wherein said common Web host contains a database under the control of each of the one or more agents and containing information in respect of a predetermined one or more clients, whereby said Web host presents the one agent with a list of said predetermined clients from which the one agent determines the degree of said regulation to be applied to those of said one or more clients which correspond to one of said one or more predetermined clients.

5. A method or regulation according to claim 4, wherein the database contains information identifying a number of said one or more agents each being a unique said one agent, the database containing agent group session tables which indicate which of said one or more clients are in, or attempting to access, a communications session with one of said one or more agents.

6. A method of regulation according to any one of claims 1 to 5, wherein the Web host responds to a prospective client attempting to access the Web host by displaying to the prospective client a display presentation into which client identifying information is enterable.

7. A method of regulation according to claim 6, wherein the Web host writes said prospective client identifying information into an agent group session list within the database.

8. A method of regulation according to any of preceding claims 5 to 8, wherein the Web host detects when one of said one or more agents disconnects or logs-off therefrom, and in such a case the Web host removes from the group session list of the disconnected agent those of said one or more clients contained therein.

9. A method of regulation according to any of claims 4 to 8, wherein the Web host is in communication with a secure data storage apparatus and retrieves data from the data storage apparatus only when: the identifying information supplied by one of said one or more clients matches the identifying information stored in the database corresponding to the client; and one of said one or more agents has authorised such access by the client.

10. Apparatus for the regulation by one or more agents of the degree of access to one or more World-Wide-Web sites available to one or more clients of said one or more World-Wide-Web sites, the apparatus comprising: one or more agent computers; a common Web host being in communication with each of said one or more agent computers and with the computers of each of said one or more clients; and communications apparatus for communicating from the one or more clients to one of the one or more agents information identifying said one or more clients, whereby the one agent computer is operable to control the common Web host to regulate the degree of said access at the Web host available to said one or more clients.

11. Apparatus according to claim 10, wherein said common Web host is said communications apparatus and is operable to request from the one or more client computers information identifying the respective client, to receive said information from the one or more client computers, and to then communicate said information to said one agent computer.

12. Apparatus according to claim 10 or claim 11, wherein said one agent computer is operable to control said common Web host so as to variably regulate said degree of access.

13. Apparatus according to any of preceding claims 10 to 12 wherein, said common Web host contains a database controllable via the one or more agent computers containing identifying information in respect of a predetermined one or more clients, and said Web host is operable to present said one agent computer with a list of said predetermined clients from the which the one agent determines the degree of said regulation to be applied to those of said one or more clients which correspond to one of said one or more predetermined clients.

14. Apparatus according to claim 13 wherein, the database contains information identifying a number of said one or more agents each being a unique said one agent, the database containing agent group session tables which indicate which of said one or more clients are in, or attempting to access, a communications session with one of said one or more agent.

15. Apparatus according to claim 14 wherein, the Web host is operable to respond to the computer of a prospective client attempting to access the Web host by displaying to the prospective client via the prospective client computer a display presentation into which client identifying information is enterable.

16. Apparatus according to claim 15, wherein the Web host is operable to write said prospective client identifying information into an agent group session list within the database.

17. Apparatus according to any of preceding claims 14 to 16, wherein the Web host is operable to detect when one of said one or more agent computers disconnects or logs-off therefrom, and in such a case to remove from the group session list of the disconnected agent those of said one or more clients contained therein.

18. Apparatus according to any of claims 13 to 17, wherein the Web host is in communication with a secure data storage apparatus and is operable to retrieve data from the data storage apparatus only when: the identifying information supplied by one of said one or more clients matches the identifying information stored in the database corresponding to the client; and one of said one or more agents has authorised such access by the client.

19. A method of control by an agent of the information accessed at one or more World-Wide-Web sites available to a client of said one or more World-Wide-Web sites, the method including the steps of: placing both the client and the agent in communication with a common Web host; the agent being in control of said common Web host so as to select which information is sent to the client by the common Web host in response to requests therefor from the client, the agent controlling how the Web host responds to such requests thereby selecting which information the client accesses.

20. A method of control according to claim 19 wherein, the client sends repeated said requests to the common Web host, and the agent controls how the Web host responds to such requests.

21. A method of control according to claim 19 or claim 20 wherein, the common Web host provides Web pages to the client which contain at least two frames, one of which contains the information that the client views and another of which contains a refresh instruction.

22. A method of control according to claim 21 wherein the frame containing the refresh instruction is less than ten pixels in extent along its minimum dimension.

23. A method of control according to claim 21 or 22 wherein, after a time delay, the client transmits back to the common Web host said refresh instruction as a request to re-transmit to the client the corresponding at least two frames.

24. A method of control according to claim 23 wherein, only the frame containing the transmitted refresh instruction is re-transmitted when the agent wishes to keep unchanged the Web page viewed by the client, while in other cases the refresh instruction is caused by the agent to correspond to a different one or more Web pages, such that the frame containing the refresh instruction and the different one or more Web page(s) are re-transmitted by the Web host.

25. A method of control according to any one of claims 19 to 24 wherein, the agent specifies which information is to be re-transmitted using a Uniform Resource Locator (URL) and communicates the URL to the Web host for retrieval by the client.

26. Apparatus for the control by an agent of the information accessed at one or more World-Wide-Web sites by a client of said one or more World-Wide-Web sites, the apparatus comprising: an agent computer; a client computer; and a common Web host in communication with said agent computer and with said client computer, the agent computer being operable to control how the Web host responds to information requests from the client so as to select which information is sent to the client by the common Web host in response to requests therefor from the client.

27. Apparatus according to claim 26 wherein, the client computer is operable to send repeated said requests to the common Web host, and the agent computer is operable to control how the Web host responds to such requests.

28. Apparatus according to claim 26 or claim 27 wherein, the common Web host is operable to provide Web pages to the client computer which contain at least two frames, one of which contains the information that the client views and another of which contains a refresh instruction.

29. Apparatus according to claim 28 wherein the frame containing the refresh instruction is less than ten pixels in height along its minimum dimension.

30. Apparatus according to claim 28 or 29 wherein, the client computer is operable to transmit back to the common Web host, after a time delay, said refresh instruction as a request to re-transmit to the client the corresponding at least two frames.

31. Apparatus according to claim 30 wherein, only the frame containing the transmitted refresh instruction is re-transmitted when the agent wishes to keep unchanged the Web page viewed by the client, while in other cases the refresh instruction is caused by the agent computer to correspond to a different one or more Web pages, such that the frame containing the refresh instruction and the different one or more Web page(s) are re-transmitted by the Web host.

32. Apparatus according to any of claims 26 to 31 wherein, the agent computer specifies the information to be re-transmitted using a Uniform Resource Locator (URL) and communicates the URL to the Web host for retrieval by the client computer.

33. A method of communicating to an agent computer the occurrence of an onload event at a client computer in receipt of data from a common Web host with which both the client computer and the agent computer are in communication, the method comprising the steps of: transmitting from the client computer to the agent computer a client signal indicating the occurrence of an onload event at the client computer.

34. A method of communicating according to claim 33 wherein, the method comprises the intermediate steps of: transmitted the client signal from the client computer to the Web host; the Web host receiving the client signal and interpreting said signal as indicating the occurrence of an onload event at the client computer; generating at the Web host a host signal indicating to the agent computer the occurrence of an onload event at the client computer; and transmitting said host signal to the agent.

35. A method of communicating according to claim 34 wherein, the client signal is in the form of a refresh request instruction.

36. A method of communicating according to claim 35 wherein, the common Web host provides Web pages to the client which contain at least two frames, one of which contains the information that the client views and another of which contains said refresh instruction.

37. A method of communicating according to claim 36 wherein the Web host responds to said refresh instruction and the client computer retains the response within a frame other than that containing the information the client views.

38. Apparatus for communicating to an agent computer the occurrence of an onload event at a client computer in receipt of data from a common Web host with which both the client computer and the agent computer are in communication, the apparatus comprising: said client computer; said agent computer; and said common Web host, wherein the client computer is operable to transmit to the agent computer a client signal indicating the occurrence of an onload event at the client computer.

39. Apparatus according to claim 38 wherein, the client computer is operable to transmit said client signal via the Web host, the Web host being operable to receive said client signal, to interpret said signal as indicating the occurrence of an onload event at the client computer, to generate a host signal indicating to the agent computer the occurrence of an onload event at the client computer, and to transmit said host signal to the agent.

40. Apparatus according to claim 41 wherein, the client signal is in the form of a refresh request instruction.

41. Apparatus according to claim 41 wherein, the common Web host is operable to provide Web pages to the client computer which contain at least two frames, one of which contains the information that the client views and another of which contains said refresh instruction.

42. Apparatus according to claim 41 wherein the Web host is operable to respond to said refresh instruction and the client computer is operable to retain the response within a frame other than that containing the information the client views.

43. A method of disabling the caching of information requested from one or more World Wide Web sites by a client of said one or more World Wide Web sites, the method including the step of rendering uniquely different each Uniform Resource Locator (URL) request from said client.

44. A method of disabling the caching of information according to claim 22 wherein, each URL request incorporates unique data representing a time stamp.

45. A method of disabling the caching of information according to claim 22 wherein, each URL request incorporates unique data representing a randomly generated number.
